(19) United States
(12) Patent Application Publication
(10) Pub. No.: US 2025/0335780 A1
(43) Pub. Date: Oct. 30, 2025

(54) MACHINE LEARNING MODEL COMPUTATIONAL GRAPH VISUALIZER WITH NODE AGGREGATION

(71) Applicant: Google LLC, Mountain View, CA (US)

(72) Inventors: Ruofei Du, San Francisco, CA (US); Jing Jin, Mountain View, CA (US); Na Li, Palo Alto, CA (US)

(21) Appl. No.: 18/646,550

(22) Filed: Apr. 25, 2024

(51) Int. Cl. G06N 3/096

(52) U.S. Cl. CPC G06N 3/096

(57) ABSTRACT

Systems, methods, devices, and related techniques for visualizing machine learning models with hierarchical structure are described in this document. In some implementations, a visualization generator receives a computational graph for a machine learning model and outputs a visual layout of the computational graph. The visual layout includes visual elements organized to present the hierarchical structure of the computational graph The visual layout can include respective visual elements for each node aggregation layer defined by the hierarchical structure. The respective visual elements for each node aggregation layer are provided in lieu of respective visual elements for individual nodes of the multiple nodes assigned to the one or more node aggregation layers.

### BACKGROUND

Machine learning models such as neural networks receive inputs and generate outputs based on the received inputs and on the values of model parameters. Machine learning models can be represented as computational graphs. Computational graphs contain nodes that represent operations of the machine learning model and edges that connect pairs of nodes in the graph and that represent data flows between operations in the machine learning model.

Visualization tools have been developed that allow computational graphs for neural networks and other types of machine learning models to be presented to a user in a visual format. Visualization tools can format computational graphs for display in a user interface, e.g., by rendering visual elements (e.g., boxes) for nodes in the computational graph and drawing lines between the visual elements to show connections among different nodes in the graph. Such tools have also been adapted to perform certain formatting tasks that can improve the display of the computational graph. For example, visual elements for nodes in a graph can be automatically and evenly spaced across the user interface to improve readability. Nonetheless, some computational graphs represent machine learning models that contain hundreds of thousands or even millions of operations that can be difficult to visualize in the limited space of a user's display device.

### SUMMARY

This specification describes technologies for visualizing computational graphs of machine learning models with hierarchical structure. In some examples, a visualization generator receives a computational graph for a machine learning model and outputs a visual layout of the computational graph. The visual layout includes visual elements organized to present the hierarchical structure of the computational graph The visual layout can include respective visual elements for each node aggregation layer defined by the hierarchical structure. The respective visual elements for each node aggregation layer are provided in lieu of respective visual elements for individual nodes of the multiple nodes assigned to the one or more node aggregation layers.

In some examples, the visual layout is generated using hierarchical aggregation techniques. The visualization generator can automatically identify related nodes in a graph of the machine learning model (e.g., nodes that define a function or a layer of a neural network) and can aggregate the related nodes so that they can be represented as a single visual element. The visualization can be presented within a user interface that allows the user to view the graph with nodes aggregated at different levels of granularity.

A first aspect includes a computer implemented method. The method includes receiving a computational graph for a machine learning model. The computational graph can include multiple nodes and multiple edges connecting different ones of the multiple nodes. Each node represents a respective operation of the machine learning model and each edge represents a data flow between a respective pair of nodes connected by the edge. The method can also include identifying a hierarchical structure for the computational graph. The hierarchical structure can define a hierarchical aggregation of nodes from the multiple nodes. A visual layout of the computational graph is generated. The visual layout includes respective visual elements for each of one or more node aggregation layers defined by the hierarchical structure. The respective visual elements for each of the one or more node aggregation layers can be provided for display in place of respective visual elements for individual nodes of the multiple nodes assigned to the one or more node aggregation layers.

The method can further include providing the visual layout of the computational graph for display in a user interface at a user device. A user input can be received through the user interface that identifies a selection of visual elements from the visual layout of the computational graph for a group of individual nodes or node aggregation layers targeted for aggregation. In response to receiving the user input, assigning the individual nodes or node aggregation layers targeted for aggregation to a new node aggregation layer in the hierarchical structure. The method also includes modifying the visual layout of the computational graph by replacing respective visual elements for the individual nodes or node aggregation layers in the group with a new visual element for the new node aggregation layer.

A second aspect includes a system. The system includes one or more processing devices and one or more memory units. The one or more memory units store instructions which, when executed by the one or more processing devices cause the system to receive a computational graph for a machine learning model. The computational graph can include multiple nodes and multiple edges connecting different ones of the multiple nodes. Each node represents a respective operation of the machine learning model and each edge represents a data flow between a respective pair of nodes connected by the edge. The instructions can further cause the system to identify a hierarchical structure for the computational graph. The hierarchical structure can define a hierarchical aggregation of nodes from the multiple nodes of the computational graph. The instructions can further cause the system to generate a visual layout of the computational graph. The visual layout can include respective visual elements for each of one or more node aggregation layers defined by the hierarchical structure. The respective visual elements for each of the one or more node aggregation layers are provided in lieu of respective visual elements for individual nodes of the multiple nodes assigned to the one or more node aggregation layers. The instructions further can cause the system to provide the visual layout of the computational graph for display in a user interface at a user device.

The instructions can further cause the system to receive, from the user interface, a user input that identifies a selection of visual elements from the visual layout of the computational graph for a group of individual nodes or node aggregation layers targeted for aggregation. In response to receiving the user input, the individual nodes or node aggregation layers targeted for aggregation can be assigned to a new node aggregation layer in the hierarchical structure. The instructions further cause the system to modify the visual layout of the computational graph by replacing respective visual elements for the individual nodes or node aggregation layers in the group with a new visual element for the new node aggregation layer.

Particular embodiments of the subject matter described in this specification can be implemented to realize one or more of the following advantages. First, creating a visual layout of a computational graph with hierarchical structure automatically without user input provides a visualization tool that more efficiently generates and effectively presents the machine learning model's architecture. In particular, large machine learning models with millions of parameters and operations are more effectively visualized when presented in a hierarchical layout. Second, the visualization is highly customizable using one-shot learning to modify the graph in real time based on a user's requirements. In particular, a user only has to manually select one example of a subgraph and the visualization generator automatically groups other subgraphs in the computational graph based on the one example.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example computing environment for a computational graph visualization generator.

FIG. 2 depicts a flowchart of an example method for generating and providing a user interface with a visual layout of a computational graph for a machine learning model.

FIG. 3 depicts a flowchart of an example method for interacting with the visual layout of a computational graph for a machine learning model.

FIG. 4 depicts a flowchart of an example method for generating a visual layout of a computational graph for a machine learning model with a user defined group of nodes.

FIG. 5 illustrates an example user interface for providing a computational graph of a machine learning model to the visualization generator.

FIG. 6A illustrates a portion of an example computational graph for a machine learning model at a first level of granularity.

FIG. 6B illustrates the portion of the example computational graph of FIG. 6A aggregated at a second level of granularity.

FIG. 6C illustrates the portion of the example computational graph of FIGS. 6A-B aggregated at a third level of granularity.

FIG. 7 illustrates an example visual layout of a computational graph for a machine learning model.

FIG. 8A illustrates a first aggregated computational graph which includes a transformer element in a machine learning model.

FIG. 8B illustrates a subgraph depicting an encoder element of the transformer element illustrated in FIG. 8A.

FIG. 8C illustrates a subgraph depicting a multilayer perceptron (MLP) block element of the encoder element illustrated in FIG. 8B.

FIG. 9 illustrates an example visual layout of a computational graph for a machine learning model with an example input and an example output.

FIG. 10 illustrates an example user interface for applying a style to a visual element representing groups of nodes in a computational graph for a machine learning model.

FIG. 11 illustrates an example visual layout with a style selected in FIG. 10 applied to a visual element.

Like reference numbers and designations in the various drawings indicate like elements.

### DETAILED DESCRIPTION

This specification describes systems, methods, and devices for visualizing computational graphs of machine learning models using hierarchical aggregation techniques. In some examples, a visualization generator receives a machine learning model as an input and outputs a visualization of the machine learning model. The visualization generator can automatically identify related nodes in a graph of the machine learning model (e.g., nodes that define a function or a layer of a neural network) and can aggregate the related nodes so that they can be represented as a single visual element. The visualization can be presented within a user interface that allows the user to view the graph with nodes aggregated at different levels of granularity.

Some examples include technologies for visualizing machine learning models with hierarchical structure. In some examples, a visualization generator receives a computational graph for a machine learning model and outputs a visual layout of the computational graph. The visual layout includes visual elements organized to present the hierarchical structure of the computational graph The visual layout can include respective visual elements for each node aggregation layer defined by the hierarchical structure. The respective visual elements for each node aggregation layer are provided in lieu of respective visual elements for individual nodes of the multiple nodes assigned to the one or more node aggregation layers.

In some examples, the computation graph for the machine learning model includes multiple nodes and multiple edges connecting different ones of the multiple nodes. Each node represents a respective operation of the machine learning model and each edge represents a data flow between a respective pair of nodes of the computational graph. In some examples, the machine learning model is a neural network (e.g., a recurrent neural network, a feedforward neural network, a convolutional neural network, a transformer neural network, or other neural network).

In some examples, the visualization generator identifies a hierarchical structure for the computational graph. The hierarchical structure can define a hierarchical aggregation of nodes from the nodes in the computational graph. In some examples, the visualization generator aggregates nodes in a graph of the machine learning model that have a same or similar structure. The visual layout of the computational graph can be presented within a user interface that allows the user view of the graph with visual elements representing the nodes aggregated at different levels of granularity.

In some examples, a visualization generator automatically generates depictions of computational graphs for large machine learning models with hierarchical aggregation by analyzing the computational graph to identify similar structures. In some examples, a user can provide one or more input examples to train the visualization generator to learn and aggregate similar components automatically. In some examples this allows a user to alter the visual layout to meet a particular use case.

In some implementations a zero-shot machine learning model is used to identify the hierarchical structure of the computational graph without user input. For example, the zero-shot machine learning model identifies an aggregation layer that defines a collection of nodes using the zero-shot machine learning model for identifying common structures in the computational graph. In some examples, the visualization generator uses a zero-shot aggregation algorithm, a one-shot aggregation algorithm, or both to generate a visual layout of the graph with hierarchical semantics.

In some examples, the visualization generator uses a hierarchical structure based on the aggregation of nodes at different levels of granularity. This allows a user to easily visualize and navigate large models (e.g., including models with millions of parameters). The visualization can also provide hierarchical information to convey the model's architecture. In some examples, one-shot aggregation configuration allows users to manually cluster a subgraph with a label to automatically aggregate nodes belonging to subgraphs with the same or similar structure.

The visualizations can be used to help users debug their machine learning models by allowing the user to easily visualize and navigate the models architecture. The techniques disclosed herein are further configured to display the edges between nodes in a manner that is organized, intuitive, and generally easy for a user to follow.

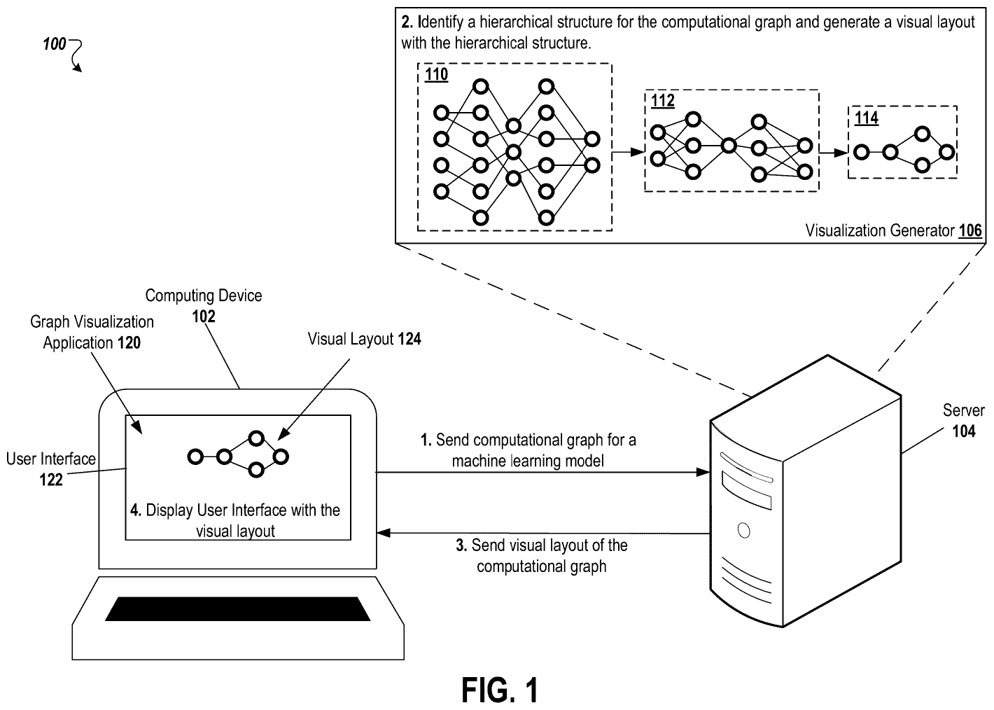

FIG. 1 illustrates an example environment 100 for a visualization generator 106. The environment 100 includes a computing device 102 and a server 104 which together operate to generate and display the visual layout 124 of the computational graph.

The server 104 is configured to communicate with the computing device 102 to receive data defining a computational graph for a machine learning model. A computational graph includes nodes connected by directed edges. Each node in the computational graph represents an operation. An incoming edge to a node represents a flow of an input into the node, i.e., an input to the operation represented by the node. An outgoing edge from a node represents a flow of an output of the operation represented by the node to be used as an input to an operation represented by another node. Thus, a directed edge connecting a first node in the graph to a second node in the graph indicates that an output generated by the operation represented by the first node is used as an input to the operation represented by the second node.

Generally, the input and outputs flowing along directed edges in the computational graph are tensors. A tensor is a multidimensional array of numeric or other values, e.g., strings, having a specific order that corresponds to the dimensionality of the array. For example, a scalar value is a 0th-order tensor, a vector of numeric values is a 1st-order tensor, and a matrix is a 2nd-order tensor.

In some implementations, the operations represented in the computational graph are neural network operations or operations for a different kind of machine learning model. A neural network can include one or more layers of nonlinear units to predict an output for a received input. Some neural networks are deep neural networks that include many hidden layers in addition to an output layer. The output of each hidden layer is used as input to another layer in the network, i.e., another hidden layer, the output layer, or both. Some layers of the network generate an output from a received input in accordance with current values of a respective set of parameters, while other layers of the network may not have parameters.

For example, the operations represented by the computational graph may be operations necessary for the neural network to compute an inference, i.e., to process an input through the layers of the neural network to generate a neural network output for the input. As another example, the operations represented by the computational graph may be operations necessary to train the neural network by performing a neural network training procedure to adjust the values of the parameters of the neural network, e.g., to determine trained values of the parameters from initial values of the parameters. In some cases, e.g., during training of the neural network, the operations represented by the computational graph can include operations performed by multiple replicas of the neural network.

By way of illustration, a neural network layer that receives an input from a previous layer can use a parameter matrix to perform a matrix multiplication between the parameter matrix and the input. In some cases, this matrix multiplication can be represented as multiple nodes in the computational graph. For example, a matrix multiplication can be divided into multiple multiplication and addition operations, and each operation can be represented by a different node in the computational graph. The operation represented by each node can generate a respective output, which flows on a directed edge to a subsequent node. After the operation represented by a final node generates a result of the matrix multiplication, the result flows, on a directed edge, to another node. The result is equivalent to an output of the neural network layer that performs the matrix multiplication.

In some other cases, the matrix multiplication is represented as one node in the graph. The operations represented by the node can receive, as inputs, an input tensor on a first directed edge and a weight tensor, e.g., a parameter matrix, on a second directed edge. The node can process, e.g., perform a matrix multiplication of the input and weight tensors to output, on a third directed edge, an output tensor, which is equivalent to an output of the neural network layer.

Other neural network operations that may be represented by nodes in the computational graph include other mathematical operations, e.g., subtraction, division, and gradient computations; array operations, e.g., concatenate, splice, split, or rank; and neural network building block operations, e.g., SoftMax, Sigmoid, rectified linear unit (ReLU), or convolutions.

The server 104 operates a visualization generator 106 that is programmed and configured to generate a visual layout 124 of the computational graph with visual elements for each node aggregation layer defined by a hierarchical structure. The visual layout 124 includes respective visual elements for each node aggregation layer defined by the hierarchical structure. The respective visual elements for each node aggregation layer is provided in lieu of respective visual elements for individual nodes of the plurality of nodes assigned to the node aggregation layers. The visualization generator 106 provides the generated visualization to the computing device 102.

The visual layout can be a visual representation of the graph at different levels of granularity. In some examples, the visual layout 124 includes visual elements for the nodes in the computational graph aggregated at different levels of granularity. In some examples, the visualization generator 106 processes a computational graph (or a subgraph portion of the computational graph) for the machine learning model to identify hierarchical features in the computational graph and to aggregate nodes in the computational graph according to the hierarchical features. In some examples, nodes in the computational graph are aggregated identifying portions across the computational graph that have a common structure. In some examples, the visualization generator 106 uses a subgraph search algorithm to identify nodes in the computational graph to aggregate. The subgraph search algorithm searches the computational graph for collections of nodes (e.g., subgraphs) that match or otherwise correspond to a defined pattern. In some implementations, the visualization generator 106 generates the visual layout 124 of the computational graph with the aggregation of the nodes at different levels of granularity using a graph drawing algorithm.

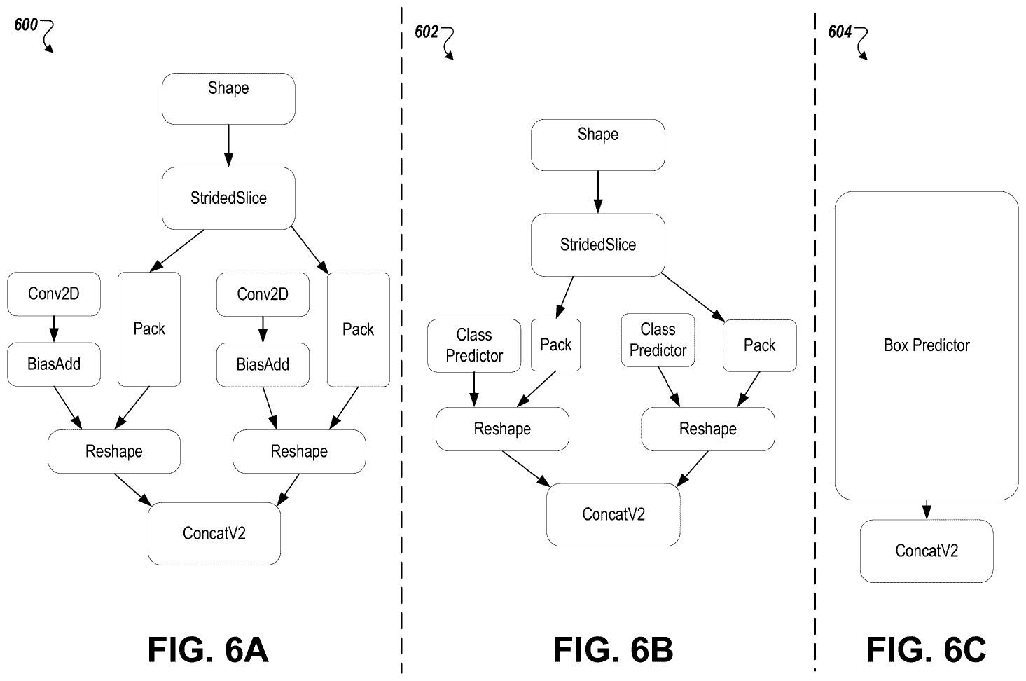

In some examples, the computational graph is aggregated at different levels of granularity by iteratively aggregating the plurality of nodes in the computational graph. For example, the computational graph is first aggregated at the highest level of granularity by analyzing the nodes in the computational graph. At its most granular level, the graph can include respective nodes for each operation in the machine-learning model represented by the graph. The operations can be defined at a relatively low level, for instance, each neuron in a neural network can be represented by one or more nodes in the most granular version of the graph. After these nodes are aggregated the computational graph is aggregated again by analyzing the nodes at the next lower level of aggregation. This process can continue until a termination condition is met, e.g., the node structures in the computational graph cannot be further aggregated. For example, the original nodes in the graph 110 can be aggregated to generate a first aggregated graph 112 and the nodes as aggregated in the first aggregated graph 112 can then be aggregated to generate a final aggregated graph 114. An example of such a process is illustrated and described in reference to FIGS. 6A-C.

In some examples, the visualization generator 106 uses a zero-shot model to identify nodes in the computational graph that have the same or similar structures. In some of these examples, the visualization generator 106 uses heuristics that are based on the machine learning model's architecture and semantics of the nodes and edges of the computational graph. For example, these heuristics can be applied to identify a main body of the computational graph, different layers of the computational graph, and connections between the layers of the computational graph. One example of a heuristic that can be used includes determining the number of nodes in a layer to identify the main body of the computational graph. Another example includes analyzing the types of nodes in the graph to identify the different layers in the model. Yet another example includes identifying connections between nodes to identify dependencies between the layers. In some implementations, the heuristics are used to automatically generate a visual layout for the computational graph.

The computing device 102 can be used to operate a graph visualization application 120. In the example shown, the computing device 102 is configured to communicate with the server 104 to send a computational graph for a machine learning model defined and receive the visual layout of the computational graph. Examples of the computing device 102 include laptops, desktops, smart phones, tablets, VR/AR devices, personal computing devices, or any other computing device with a display or configured to interface a display.

The graph visualization application 120 presents a user interface 122 with a visual layout 124 of the computational graph for the machine learning model graph. In some implementations, the graph visualization application 120 is a web application. In some examples, the graph visualization application 120 allows a user to adjust the displayed level of granularity via inputs at the user interface 122. For example, a user can select a visual element to replace the visual element with the next layer of visual elements representing the nodes aggregated at a higher level of granularity. In some examples, the application may start with showing the user the graph at a low level of granularity (corresponding to a high level of aggregation), thereby allowing the user to quickly identify different portions of the graph that are of interest. A user can then select a node, and in response, the selected node expands to reveal the nodes in that portion of the graph at a more granular level.

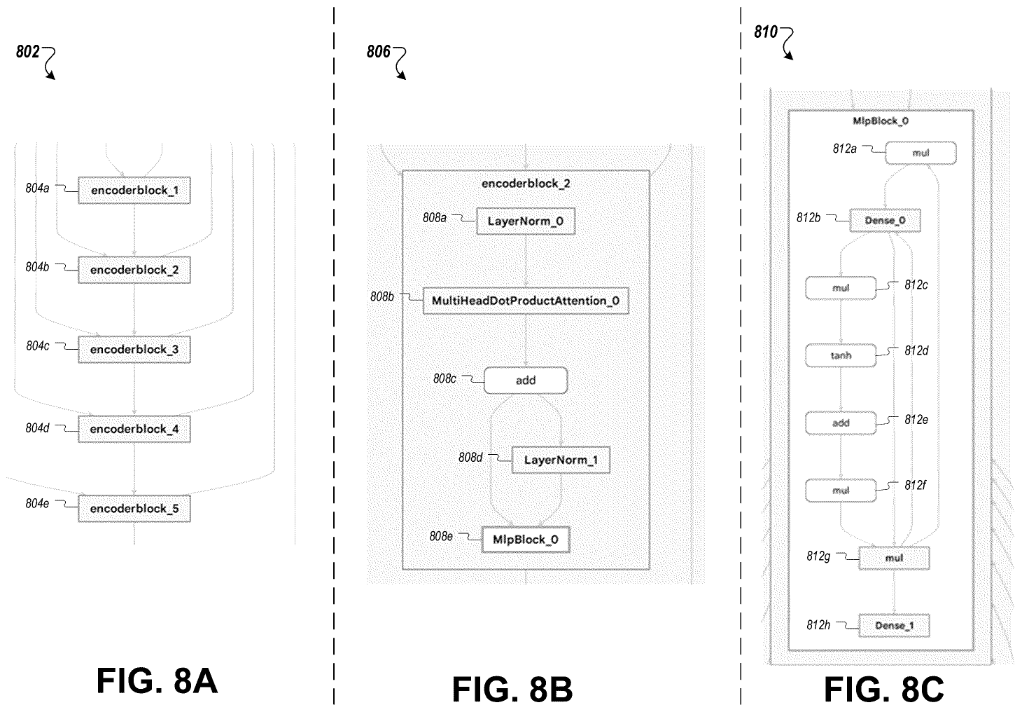

By way of illustration, FIG. 8A shows the visual layout for a first aggregated computational graph 802. The first aggregated computational graph 802 includes a collection of aggregated nodes 804a-e representing a series of encoder blocks in a neural network. The first aggregated computational graph 802 is displayed at a low level of granularity in that nodes representing low-level operations of the neural network have been replaced by aggregated nodes 804a-e that each represent a subgraph, i.e., a collection of nodes from the original computational graph. The subgraph represented by an aggregated node 804 can be referred to as a node aggregation layer. In some implementations, nodes are aggregated in a hierarchical fashion to form a hierarchical structure for the computational graph. Thus, each iteration of aggregation forms a new node aggregation layer at a higher level of the hierarchical structure. When a user selects the visual element for one of the aggregated nodes 804a-e in the first aggregated computational graph 802, the visual element for the selected node expands to reveal the nodes contained in the aggregation layer of the selected node (i.e., nodes at one or more lower layers of the hierarchical structure). For example, FIG. 8B shows that when the visual element for the encoderblock_2 aggregated node 804b is selected, the nodes 808a-e of subgraph 806 are revealed. The nodes 808a-e can include original nodes representing individual low-level operations from the original computational graph, aggregated nodes representing subgraphs at a lower hierarchical level than the subgraphs represented by nodes 804a-e, or both. In some implementations, only the visual element for the specific, aggregated node that the user selected is expanded in response to the user's selection. In other implementations, visual elements for one or more second aggregated nodes can also expand in response to the user's selection of a first aggregated node when a relationship exists between the first and second aggregated nodes (e.g., all other encoder block nodes can be expanded in response to the user's selection of a visual element for one of the encoder block nodes). In some implementations, the user can continue to drill down in the graph to lower levels of the hierarchical structure to reveal portions of the graph at increasingly higher levels of granularity. For example, FIG. 8b shows how selection of the visual element for node 808e can cause the MlpBlock_0 node to expand and show nodes 812a-h of subgraph 810.

In some examples, a user can zoom in or out on the user interface (e.g., by scrolling or other user interface gesture) to adjust the level of granularity.

In some examples, when the visual layout (visual representation) of a computational graph is displayed, a user can define a group of nodes to aggregate. For example, a user may select a set of visual elements representative of common nodes and assign a label to the set of visual elements. These selections are provided to the visualization generator 106 which will process the computational graph to further include an aggregation of nodes with the same or similar structure. In some implementations, the visual layout 124 is then updated to further include the aggregation of the user defined group in response to receiving the selections (e.g., in real time). In some examples, a rectangle selection tool to select a group of nodes. In some examples, a free-hand selection tool is used to select the group of nodes. In some examples, a user can enter a human-readable label for the group of nodes. In other examples, the visualization generator 106 automatically labels the group of nodes.

In some of these examples, a one-shot model is conditioned based on the user selections. The one shot model is used to automatically cluster nodes with a similar architecture with the label provided by the user. In some examples, the user interface is configured to multi-select nodes in the graph for the user defined group. In other examples, a user can drag a circle or rectangle over the nodes to select nodes for the user defined group. In some examples, this allows a user to fill a layer to include information that a common namespace does not cover (e.g., a model author defined layer). In some examples, this allows a user to hide areas of nodes that are not important to show (e.g., a user may hide sections which are not relevant to a debugging process). In some examples, the one shot model is used to allow a user to search for a particular node or subgraph with a particular structure.

In one example, the user interface 122 receives a user input that identifies a selection of visual elements from the visual layout of the computational graph for a group of individual nodes or node aggregation layers targeted for aggregation. In some examples, the visualization generator receives the selection and identifies a pattern associated with the group of individual nodes or node aggregation layers targeted for aggregation and searches the computational graph for other occurrences of the pattern, and automatically creating additional aggregation layers for the nodes or the layers that match the pattern. The visual layout is then modified by replacing respective visual elements for the individual nodes or node aggregation layers in the group with a new visual element for the new node aggregation layer. The modified user interface is provided to the computing device 102 to display on the user interface 122.

In some examples, the visual layout 124 of the computational graph is presented in a hierarchical layout. In this layout the computational graph is divided into different layers, and each layer is represented as a node in the graph. The edges between the nodes represent the connections between the layers. In other examples, the visual layout 124 of the computational graph is presented in a force-directed layout where the nodes in the graph are attracted to each other and/or they are repelled by each other and the final layout is determined by the forces between the nodes. In some examples, the visual layout 124 of the computational graph is presented in a treemap, where the computational graph is represented as a tree and each node in the tree is presented as a rectangle and the size of the rectangle represents the size of the node. In some examples, the visualization colors the nodes based on the weights of the parameters defined by the nodes. In some examples, a user can select the type of layout or adjust the layout of the nodes. In some examples a user can apply the force directed layout and drag the node in a direction and similar nodes will be dragged towards the same region. In some examples, the machine learning model graph visualization is in a multi-level intermediate representation (“MLIR”) format.

The example shown in FIG. 1 includes a process for generating and displaying the visual layout 124 of the computational graph for the machine learning model. At stage 1, the computing device 102 sends a computational graph for a machine learning model to the server 104. At stage 2, the server operates the visualization generator 106 to identify a hierarchical structure for the computational graph and generate a visual layout with the hierarchical structure. At stage 3, the server 104 sends the visual layout 124 of the computational graph to the computing device 102. At stage 4 the computing device 102 displays the user interface 122 with the visual layout 124 of the computational graph.

Although the example shown includes a single server 104 other examples can include multiple servers. For example, multiple servers can be used to provide redundancy, specialized services, geographic based services, or combinations thereof. In some examples, a cloud computing system is used. In alternative examples, the visualization generator 106 is operated at the computing device 102.

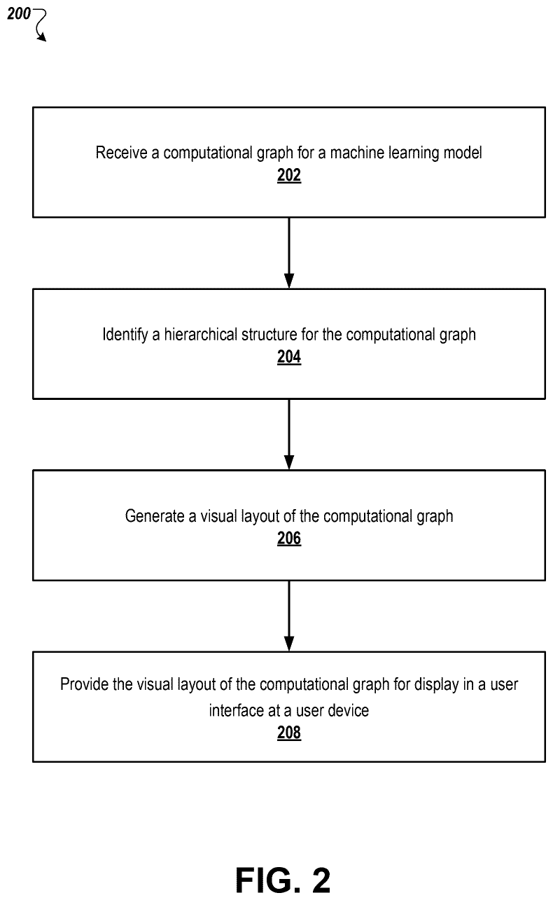

FIG. 2 illustrates an example method 200 for generating and providing a user interface with a visual layout of a computational graph for a machine learning model. In some implementations, the method 200 is performed at a server (or other remote computing environment) such as the server 104 shown in FIG. 1. In other examples, the method 200 is performed at a computing device (e.g., at a local computing device) such as the computing device 102 shown in FIG. 1. The method includes the stages 202, 204, 206, and 208.

At stage 202, the visualization generator receives a computational graph for a machine learning model. In some examples, the computational graph is uploaded to the computing device operating the visualization generator. In other examples, a link is provided that allows the visualization generator to access the structure and information of the computational graph at the linked endpoint.

At stage 204, the visualization generator identifies a hierarchical structure for the computational graph. The hierarchical structure defines. a hierarchical aggregation of nodes from the plurality of nodes of the computational graph. In some examples operation 204 includes aggregating the nodes in the graph at different levels of granularity. In some examples, identifying the hierarchical structure for the computational graph includes performing a search of the computational graph for subgraphs with similar architectures. In some examples, a zero shot machine learning model is used to automatically (e.g., without user input) identify subgraphs in the computational graph with similar architectures. In some examples, the operation 204, includes iteratively aggregating the plurality of nodes from a high level of granularity to a low level of granularity.

In some examples, identifying a hierarchical structure for the computational graph is further based on a domain of the machine learning model. In some examples, a neural network is used to identify a hierarchical structure for the computational graph. In some of these examples, the neural network is trained on training example machine learning models with labeled hierarchical structures.

At stage 206, the visualization generator generates a visual layout of the computational graph. The visual layout includes respective visual elements for each of one or more node aggregation layers defined by the hierarchical structure. The respective visual elements for each of the one or more node aggregation layers are provided in lieu of respective visual elements for individual nodes of the plurality of nodes assigned to the one or more node aggregation layers. In some examples, the operation 206 includes generating a visual layout of the computational graph based on the aggregation of the nodes.

At stage, the visualization generator provides the visual layout of the computational graph for display in a user interface at a user device. In some examples, the visual layout is presented within a web application. In some examples, the visual layout is provided with a debugging tool for the machine learning model.

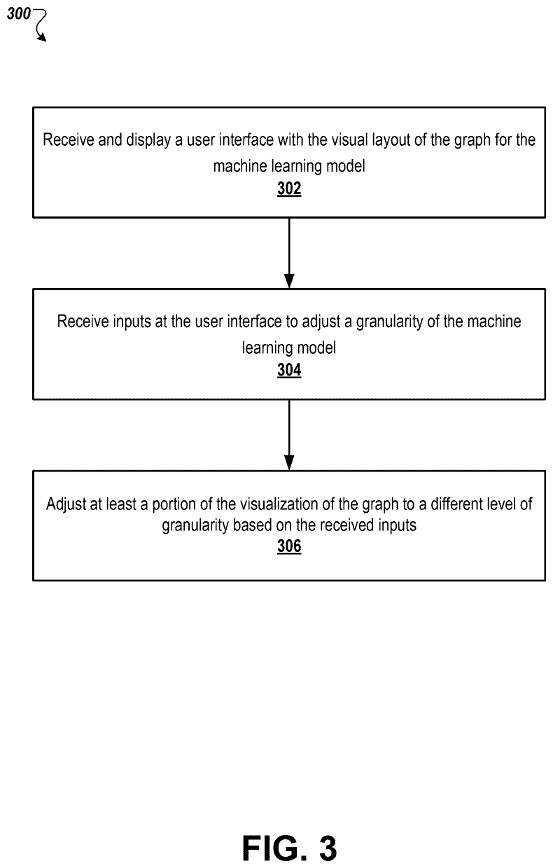

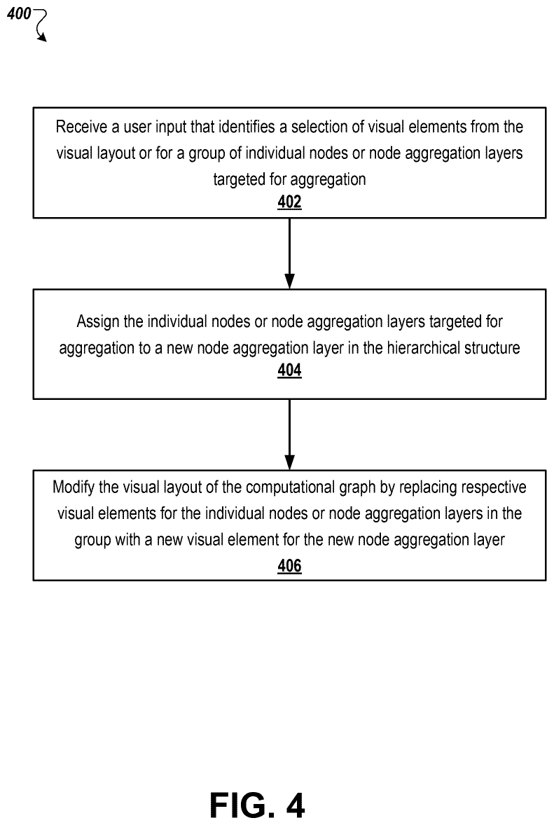

FIG. 3 illustrates an example method for interacting with the visual layout of a computational graph for a machine learning model. The method 300 is performed at a computing device executing the graph visualization application (e.g., the computing device 102 and the graph visualization application 120 shown in FIG. 1). The method 300 includes stages 302, 304, and 306.

At stage 302, the computing device receives a user interface with a visual layout of the computational graph of the machine learning model. The visual layout includes visual elements representing one or more nodes of the computational graph. For example, a visual element may represent a component of the computational graph, such as an encoder and another visual element may represent a plurality of encoders in a common structure.

The visual layout can include respective visual elements for each of one or more individual nodes from the plurality of nodes of the computational graph The visual layout can also include visual elements that represent connections between individual nodes or groups of nodes.

At stage 304, the computing device receives inputs at the user interface to adjust the displayed level of granularity for a visual element in the visual layout of the machine learning model. For example, a user can select a visual element and the next layer of visual elements are exposed showing the portion of the graph at a higher level of granularity.

At stage 306, the user interface adjusts at least a portion of the visualization of the graph to a different level of granularity based on the received inputs. The operations 304 and 306 are performed in real time (e.g., as selections received at the user interface).
illustrates an example method 400 for generating a visual layout of a computational graph for a machine learning model with a user defined group of nodes. In some implementations, the method 200 is performed at a server (or other remote computing environment) such as the server 104 shown in FIG. 1. In other examples, the method 200 is performed at a computing device (e.g., at a local computing device) such as the computing device 102 shown in FIG. 1. The method 400 includes stages 402, 404, and 406.

At stage 402, the visualization generator receives a user input that identifies a selection of visual elements from the visual layout for a group of individual nodes or node aggregation layers targeted for aggregation. In some examples, the inputs include a tag labeling the group of individual nodes or node aggregation layers targeted for aggregation. The selection of visual elements are received at a user interface of the graph visualization engine.

At stage 404, the visualization generator assigns the individual nodes or node aggregation layers targeted for aggregation to a new node aggregation layer in the hierarchical structure. The group of individual nodes or node aggregation layers targeted for aggregation can include individual nodes from the plurality of nodes and at least one aggregation layer for at least one sub-group of nodes from the plurality of nodes. In some examples, the operation 404 includes aggregating the plurality of nodes in the graph that have a similar architecture to the selected group of nodes.

In some examples, stage 404 includes conditioning a one-shot machine learning model on the group of individual nodes or node aggregation layers targeted for aggregation and processing the computational graph with the one-shot machine learning model to assign the individual node or node aggregation layers targeted for aggregation to the new node aggregation layer in the hierarchical structure. In some examples, the one-shot machine learning model identifies a pattern associated with the group of individual nodes or node aggregation layers targeted for aggregation and searches the computational graph for other occurrences of the pattern, and automatically creating additional aggregation layers for the nodes or the layers that match the pattern

At stage 406, the visualization generator modifies the visual layout of the computational graph by replacing respective visual elements for the individual nodes or node aggregation layers in the group with a new visual element for the new node aggregation layer. In some examples, the new visual element for the new aggregation layer is labeled with a user defined tag. In other examples, the visualization generator generates a tag to label the new visual element for the new node aggregation layer. The modified visual layout for display is provided to the computing device to present the modified visual layout on the user interface of the graph visualization application.

In some examples, the method 400 is performed in response to the user interface receiving the selection of visual elements. For example, such that that visualization is updated to include the user defined visual element in real time.

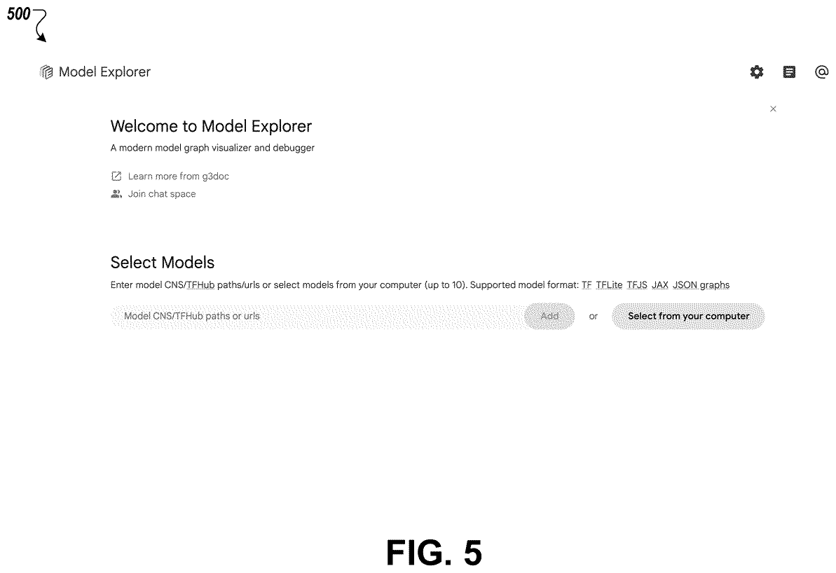

FIG. 5 illustrates an example user interface 500 for providing a computational graph for a machine learning model to the visualization generator. In this example, a user can enter a path or link to the machine learning model to provide the model to the visualization generator. In some examples, a model file can be dragged or dropped to upload the model. In the example shown, the model can be any of a variety of supported formats.

FIGS. 6A-C illustrates an example for aggregating nodes of a portion of a computational graph for a machine learning model at different levels of granularity. The example shown is a portion of the computational graph for illustrative purposes. In some examples, the computational graph can include a large number of nodes (e.g., millions or more) that can be aggregated into multiple groups of nodes at different levels of granularity.

FIG. 6A illustrates a portion of a computational graph 600 for a machine learning model at a first level of granularity. In this example, the visualization generator 106 processes the computational graph 600 and identifies the “Conv2D” operation and “Bias Add” operation as a structure of a “class predictor” subgraph. These nodes are aggregated to generate the graph 602 shown in FIG. 6B. In some examples, a user defines a group of nodes to aggregate. For example, a user can select the “Conv2D” operation and “Bias Add” operation and label the group with a tag (e.g., labeling the group “class predictor”) the visualization generator can process the graph to aggregate similar nodes throughout the computational graph and label a corresponding element with the tag. In other examples, the class predictor is generated automatically by identifying the corresponding structure in the computational graph.

FIG. 6B illustrates the portion of the example computational graph of FIG. 6A aggregated at a second level of granularity. As discussed in reference to FIG. 6A, the class predictor group of nodes is an abstracted representation of the “Conv2D” operation and “Bias Add” operation. The several nodes (e.g., all of the nodes except the “ConcatV2“operation” shown in the graph 602 are aggregated as part of the box predictor element shown in the graph 604 in FIG. 6C.

FIG. 6C illustrates the portion of the computational graph of FIGS. 6A-B aggregated at a third level of granularity. As discussed in reference to FIGS. 6A-6B, the box predictor element represents the nodes shown in the graphs 600 and 602 excluding the “concatV2” operation which in this example is not aggregated as part of the “Box Predictor.”

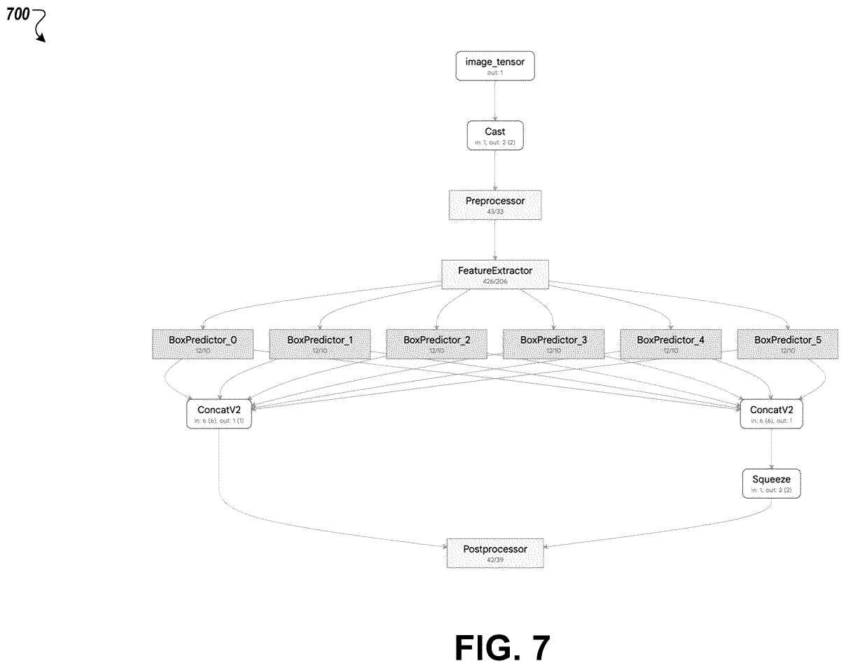

FIG. 7 illustrates an example of a visual layout 700 of a computational graph for a machine learning model. The visual layout 700 includes several visual elements representing nodes or groups of nodes in the computational graph for the machine learning model. The visual elements correspond to node aggregation layers defined by the hierarchical structure For example, each “BoxPredictor” is representative of a low granularity (e.g., as shown in FIG. 6A) and the layout can be adjusted (e.g., via a user input to view other node aggregation layers (e.g., the representations shown in FIGS. 6A-6B.

FIGS. 8A-C illustrate a portion of a visual layout of a computational graph for a machine learning graph displayed at different levels of granularity. FIG. 8A illustrates a first aggregated computational graph 802 which includes a transformer element in a machine learning model. FIG. 8B illustrates subgraph 806 depicting an encoder element of the transformer element illustrated in FIG. 8A. FIG. 8C illustrates a subgraph 810 depicting a multilayer perceptron (MLP) block element 805 of the encoder element illustrated in FIG. 8B.

In some examples, when a user selects the encoder element (e.g., “encoderblock_2”) in the transformer element the user interface expands the encoder element to show structure of the next node aggregation layer, as shown in FIG. 8B. When a user selects the MLP block element in the encoder element the user interface updates to expand the MLP element as shown in FIG. 8C. Similarly, a user can select (e.g., toggle) each element to remove the details at the higher level of granularity. For example, a user can select a region in the “encoderblock_2” to adjust the user interface back to the transformer as shown in FIG. 8A. In this manner a user can expand or minimize components of the visual layout to understand the structure of the computational graph.

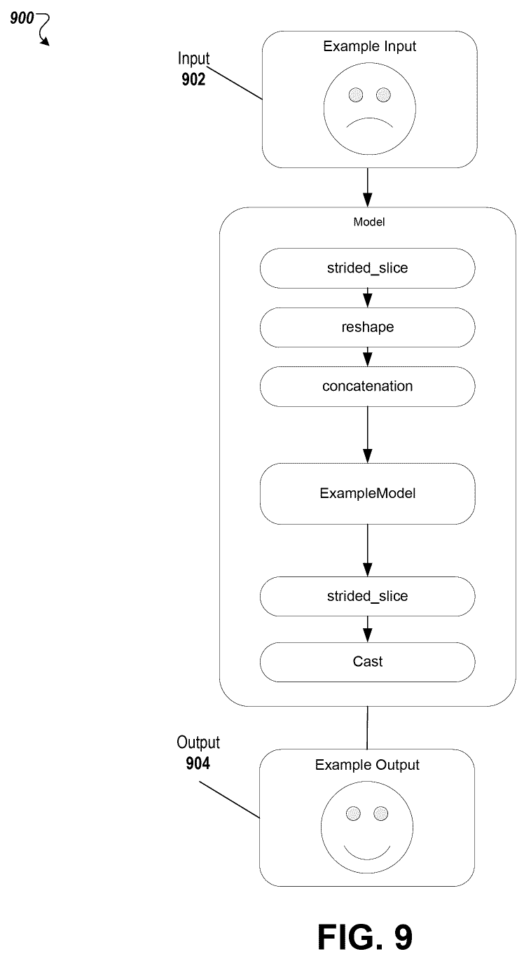

FIG. 9 illustrates an example visual layout 900 of a machine learning graph with an example input element 902 and an example output element 904. In some examples, the computational graph includes an input that was provided to the machine learning model to generate an output. The inputs and outputs can be processed by the visualization generator and included in the visual layout 900. In this example, the input element 902 is representative of an input that was provided to the machine learning model and the output element 904 is representative of the output generated by the machine learning model. This allows a user to observe and present the machine learning model in the context of a specific input and generated output.

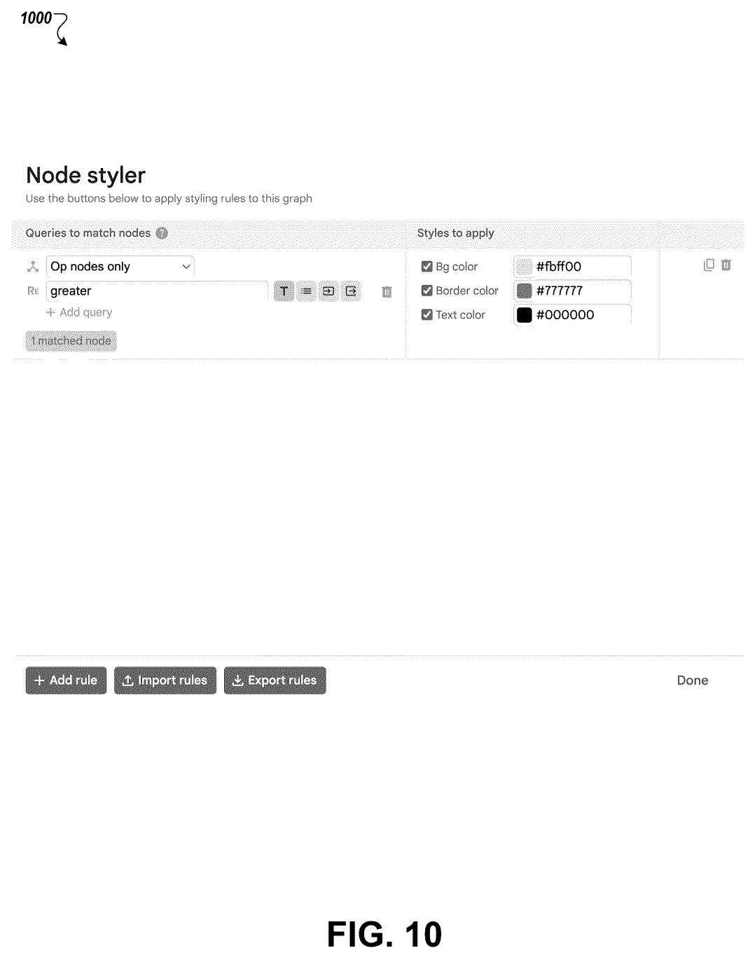

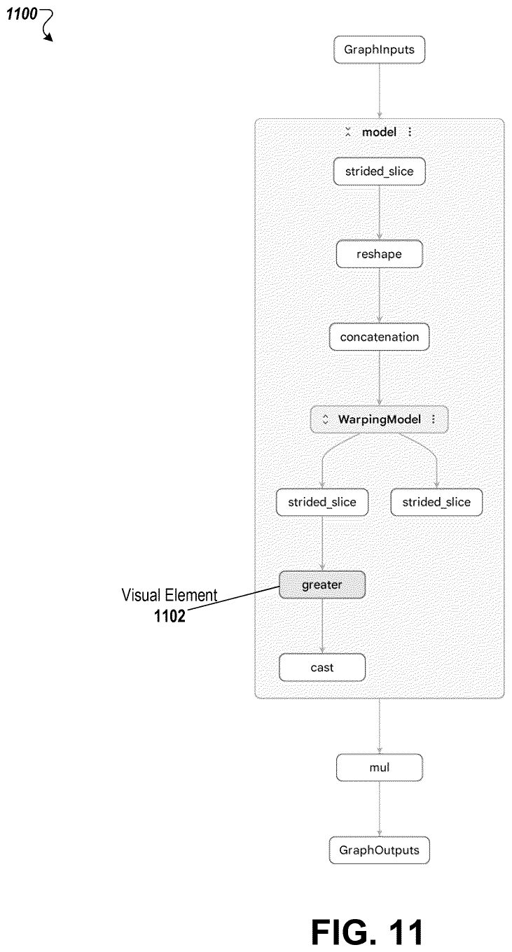

FIGS. 10 and 11 illustrate an example for applying a style to a visual element in a visual layout.

FIG. 10 illustrates an example user interface 1000 for applying a style to a visual element representing groups of nodes in a computational graph for a machine learning model. In this example, the user interface 1000 can receive inputs for selecting a node, group of nodes, node aggregation layer, or combinations. In the example shown, the nodes are selected using a query for a certain type of node, where the type of node is selected from a drop down menu. Next, the user interface receives inputs selecting a style to apply. In the example shown, the style includes a fill color, border color, and text color for the visual element. However, the style can include other features such as sizes, shapes, fonts, font sizes, font styles (e.g., bold, italicized, underlined, other font styles), or other visual style elements to include or apply to the visual element. The user interface 1000 also allows a user to add the style a as a rule (e.g., to use in other visualizations). The user interface 1000 can also import or export style rules. For example, a user can import a set of rules to quickly update the style to their visualization with a set of predefined style rules.

FIG. 11 illustrates an example visual layout 1100 with a style selected in FIG. 10 applied to a visual element. In this example, the visual element 1102 is updated to match the style selected in FIG. 10. Although in this example only one visual element matches the rules to apply the selected style, in other examples multiple visual elements will match the rules and will be updated on visual layout to match the selected style.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine-learning models can also include, for example, special-purpose hardware accelerator units for processing common and compute-intensive parts of machine learning training or production, i.e., inference, workloads.

Machine-learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a computational graph for a machine learning model, the computational graph including a plurality of nodes and a plurality of edges connecting different ones of the plurality of nodes, each node representing a respective operation of the machine learning model and each edge representing a data flow between a respective pair of nodes connected by the edge;
identifying a hierarchical structure for the computational graph, the hierarchical structure defining a hierarchical aggregation of nodes from the plurality of nodes of the computational graph;
generating a visual layout of the computational graph, the visual layout including respective visual elements for each of one or more node aggregation layers defined by the hierarchical structure, wherein the respective visual elements for each of the one or more node aggregation layers are provided in place of respective visual elements for individual nodes of the plurality of nodes assigned to the one or more node aggregation layers; and
providing the visual layout of the computational graph for display in a user interface at a user device.

2. The computer-implemented method of claim 1, further comprising:
receiving, from the user interface, a user input that identifies a selection of visual elements from the visual layout of the computational graph for a group of individual nodes or node aggregation layers targeted for aggregation;
in response to receiving the user input, assigning the individual nodes or node aggregation layers targeted for aggregation to a new node aggregation layer in the hierarchical structure; and
modifying the visual layout of the computational graph by replacing respective visual elements for the individual nodes or node aggregation layers in the group with a new visual element for the new node aggregation layer.

3. The computer-implemented method of claim 2, further comprising:
conditioning a one-shot machine learning model on the group of individual nodes or node aggregation layers targeted for aggregation; and
processing the computational graph with the one-shot machine learning model to assign the individual node or node aggregation layers targeted for aggregation to the new node aggregation layer in the hierarchical structure.

4. The computer-implemented method of claim 2, the method further comprising:
providing the modified visual layout for display in the user interface at the user device.

5. The computer-implemented method of claim 1, wherein identifying the hierarchical structure for the computational graph includes performing a search of the computational graph for subgraphs with similar architectures.

6. The computer-implemented method of claim 1, wherein identifying the hierarchical structure for the computational graph includes processing the computational graph with a one-shot machine learning model to identify subgraphs with similar architectures.

7. The computer-implemented method of claim 1, wherein the hierarchical structure includes a main body of the computational graph, layers of the computational graph, and connections between the layers of the computational graph.

8. The computer-implemented method of claim 7, wherein processing the computational graph further includes determining a number of nodes in each layer of the computational graph to identify a main body of the computational graph.

9. The computer-implemented method of claim 7, wherein processing the computational graph further includes analyzing types of nodes in the computational graph to identify different layers in the machine learning model.

10. The computer-implemented method of claim 7, wherein processing the computational graph further includes analyzing a plurality of edges between the plurality of nodes in the computational graph to identify dependencies between the layers.

11. The computer-implemented method of claim 2, wherein the user input further includes a tag labeling the group of individual nodes or node aggregation layers targeted for aggregation and the new visual element for the new node aggregation layer is labeled with the tag.

12. The computer-implemented method of claim 1, wherein the visual layout of the computational graph is generated in a hierarchical layout.

13. The computer-implemented method of claim 1, wherein the visual layout of the computational graph is presented within a debugging tool for the machine learning model.

14. The computer-implemented method of claim 1, further comprising:
providing an input to the machine learning model to generate an output, wherein the visual layout of the computational graph includes an input visual element of the input and an output visual element of the output at corresponding portions of the visual layout of the computational graph.

15. The computer-implemented method of claim 1, wherein the machine learning model is a neural network.

16. The computer-implemented method of claim 15, wherein the neural network includes at least one selected from the following group:
(a) a recurrent neural network;
(b) a feedforward neural network;
(c) a convolutional neural network; or
(d) a transformer neural network.

17. The computer-implemented method of claim 1, wherein the user interface is included within a web application.

18. The computer-implemented method of claim 1, wherein identifying a hierarchical structure for the computational graph is further based on a domain of the machine learning model.

19. The computer-implemented method of claim 1, wherein a neural network is used to identify a hierarchical structure for the computational graph, wherein the neural network is trained on training example machine learning models with labeled hierarchical structures.

20. The computer-implemented method of claim 1, wherein identifying a hierarchical structure for the computational graph includes iteratively aggregating the plurality of nodes from a high level of granularity to a low level of granularity.

21. A system comprising:
one or more processing devices; and
one or more memory units storing instructions which, when executed by the one or more processing devices cause the system to:
receive a computational graph for a machine learning model, the computational graph including a plurality of nodes and a plurality of edges connecting different ones of the plurality of nodes, each node representing a respective operation of the machine learning model and each edge representing a data flow between a respective pair of nodes connected by the edge;
identify a hierarchical structure for the computational graph, the hierarchical structure defining a hierarchical aggregation of nodes from the plurality of nodes of the computational graph;
generate a visual layout of the computational graph, the visual layout including respective visual elements for each of one or more node aggregation layers defined by the hierarchical structure, wherein the respective visual elements for each of the one or more node aggregation layers are provided in place of respective visual elements for individual nodes of the plurality of nodes assigned to the one or more node aggregation layers; and
provide the visual layout of the computational graph for display in a user interface at a user device.

22. The system of claim 21, wherein the instructions further cause the system to:
receive, from the user interface, a user input that identifies a selection of visual elements from the visual layout of the computational graph for a group of individual nodes or node aggregation layers targeted for aggregation;
in response to receiving the user input, assigning the individual nodes or node aggregation layers targeted for aggregation to a new node aggregation layer in the hierarchical structure; and
modify the visual layout of the computational graph by replacing respective visual elements for the individual nodes or node aggregation layers in the group with a new visual element for the new node aggregation layer.

23. The system of claim 22, wherein the group of individual nodes or node aggregation layers targeted for aggregation include at least one individual node from the plurality of nodes and at least one aggregation layer for at least one sub-group of nodes from the plurality of nodes.

24. The system of claim 21, wherein the hierarchical structure includes a first node aggregation layer that defines a collection of nodes aggregated without user input based on a zero-shot machine learning model.

25. The system of claim 22, wherein to identify a hierarchical structure for the computational graph includes to:
identify a pattern associated with the group of individual nodes or node aggregation layers targeted for aggregation; and
search the computational graph for other occurrences of the pattern, and automatically create additional aggregation layers for nodes or layers that match the pattern.

26. The system of claim 21, wherein the visual layout further includes respective visual elements for each of one or more individual nodes from the plurality of nodes of the computational graph.

27. The system of claim 26, wherein the visual layout further includes visual elements that represent connections between individual nodes or groups of nodes;
wherein the visual layout of the computational graph is generated by aggregating at least a portion of the plurality of nodes at different levels of granularity based on architectural features identified in the computational graph.
